(19) United States
(12) Patent Application Publication
(10) Pub. No.: US 2024/0351462 A1
(43) Pub. Date: Oct. 24, 2024

(54) SYSTEM AND METHOD FOR CHARGING ELECTRIC VEHICLES

(71) Applicant: Ford Global Technologies, LLC, Dearborn, MI (US)

(72) Inventors: Yifan Chen, Ann Arbor, MI (US); Raj Sohmshetty, Canton, MI (US); Kurt Michael Lundeen, Novi, MI (US); Smruti Panigrahi, Novi, MI (US)

(73) Assignee: Ford Global Technologies, LLC, Dearborn, MI (US)

(21) Appl. No.: 18/302,705

(22) Filed: Apr. 18, 2023

(51) Int. Cl. B60L 53/35; B25J 5/00; B60L 53/14; H02J 7/00

(52) U.S. Cl. CPC B60L 53/35; B25J 5/005; B60L 53/14; H02J 7/0042

(57) ABSTRACT

A system for charging electric vehicles that includes a rail structure, a mobile base unit, a battery charge station and a battery. The mobile base unit is supported by the rail structure. The mobile base unit includes a movable base connected to the rail structure and a drive motor configured to move the movable base along the rail structure. The movable base defines a first battery compartment. The battery charge station defines a second battery compartment. The battery is movable by the movable base between a first position in which the battery is received in the first battery compartment and electrically coupled to the mobile base unit to provide power to the drive motor, and a second position in which the battery is received in the second battery compartment and electrically coupled to the battery charge station to charge the battery.

### FIELD

The present disclosure relates to a system and method for charging electric vehicles.

### BACKGROUND

The statements in this section merely provide background information related to the present disclosure and may not constitute prior art.

Various types of automotive vehicles such as battery electric vehicles (BEVs), hybrid electric vehicles (HEVs), plug-in electric vehicles (PHEVs), or fuel cell vehicles, for example, include one or more electric motors that employs electrical energy stored in an energy storage apparatus, such as one or more vehicle batteries, to perform one or more propulsion-based operations. The energy storage apparatus requires periodic charging by connecting the energy storage apparatus to a power source.

The teachings of the present disclosure address these and other issues with charging the energy storage apparatus of electric vehicles.

### SUMMARY

This section provides a general summary of the disclosure and is not a comprehensive disclosure of its full scope or all of its features.

In one form, the present disclosure provides a system for charging electric vehicles that includes a rail structure, a mobile base unit, a first battery charge station, and a first battery. The mobile base unit is supported by the rail structure. The mobile base unit includes a movable base connected to the rail structure, a drive motor configured to move the movable base along the rail structure, and a robotic arm secured to the movable base. The movable base defines a first battery compartment. The first battery charge station is connected to a power source and defines a second battery compartment. The first battery is movable between a first position in which the first battery is received in the first battery compartment and electrically and mechanically coupled to the mobile base unit to provide power to the drive motor and the robotic arm, and a second position in which the first battery is received in the second battery compartment and electrically and mechanically coupled to the first battery charge station to charge the first battery. The movable base moves the first battery from the first position to the second position.

In variations of the system of the above paragraph, which can be implemented individually or in any combination: the first battery compartment is horizontally aligned with the second battery compartment; the robotic arm hangs below the movable base; first and second guide members are disposed within the first battery compartment and are configured to align and support the first battery within the first battery compartment, the first guide members are located at an upper portion of the first battery compartment and the second guide members located at a lower portion of the first battery compartment; third and fourth guide members are disposed within the second battery compartment and are configured to align and support the first battery within the second battery compartment, the third guide members are located at an upper portion of the second battery compartment and the fourth guide members are located at a lower portion of the second battery compartment; the movable base defines a third battery compartment opposite the first battery compartment; a second battery charge station is spaced apart from the movable base, the second battery charge station is connected to the power source and defines a fourth battery compartment; a second battery is movable between a first position in which the second battery is received in the third battery compartment and electrically and mechanically coupled to the mobile base unit to provide power to the drive motor and the robotic arm, and a second position in which the second battery is received in the fourth battery compartment and electrically and mechanically coupled to the second battery charge station to charge the second battery; the first battery charge station is located at a first end of the rail structure and the second battery charge station is located at a second end of the rail structure that is opposite the first end; the first battery includes a body and first and second locking members, the first locking member extends from a first end of the body toward the first battery charge station and the second locking member extends from a second opposite end of the body toward the mobile base unit; a first locking pin is at least partially disposed within the first battery charge station and is movable between a first position in which the first locking pin is disengaged from the first locking member to allow the first battery to move within the second battery compartment and a second position in which the first locking pin is engaged with the first locking member to inhibit the first battery to move within the second battery compartment; a second locking pin is at least partially disposed within the movable base and is movable between a first position in which the second locking pin is disengaged from the second locking member to allow the first battery to move within the first battery compartment and a second position in which the second locking pin is engaged with the second locking member to inhibit the first battery to move within the first battery compartment; the first and second locking pins are spring loaded locking pins; the robot arm includes a plurality of segments connected to each other such that the robot arm has multiple degrees of freedom; a sensor is configured to measure a distance between the first battery charge station and the mobile base unit; and the movable base is connected to the rail structure by a gear assembly including gear wheels.

In another form, the present disclosure provides a system for charging electric vehicles that includes a rail structure, a mobile base unit, a first battery charge station, a first battery, and a controller. The mobile base unit is supported by the rail structure. The mobile base unit includes a movable base connected to the rail structure, a drive motor configured to move the movable base along the rail structure, and a robotic arm secured to the movable base. The first battery charge station is connected to a power source and aligned with the movable base. The first battery is movable between a first position in which the first battery is electrically and mechanically coupled to the mobile base unit to provide power to the drive motor and the robotic arm, and a second position in which the first battery is electrically and mechanically coupled to the first battery charge station to charge the first battery. The controller is configured to: obtain a charge request from one or more electric vehicles, obtain a current power level of the first battery, determine a power level required to perform the charge request, and move the first battery from the first position to the second position using the movable base in response to the current power level being less than the determined power level.

In variations of the system of the above paragraph, which can be implemented individually or in any combination: a sensor is configured to measure a distance between the first battery charge station and the mobile base unit; the robotic arm hangs below the movable base; the movable base defines a first battery compartment, the first battery is received in the first battery compartment when the first battery is in the first position; the first battery charge station defines a second battery compartment that is aligned with the first battery compartment, the first battery is received in the second battery compartment when the first battery is in the second position; first and second guide members are disposed within the first battery compartment and are configured to align and support the first battery within the first battery compartment, the first guide members are located at an upper portion of the first battery compartment and the second guide members are located at a lower portion of the first battery compartment; third and fourth guide members are disposed within the second battery compartment and are configured to align and support the first battery within the second battery compartment, the third guide members are located at an upper portion of the second battery compartment and the fourth guide members are located at a lower portion of the second battery compartment; the movable base defines a third battery compartment opposite the first battery compartment; a second battery charge station is aligned with the movable base, the second battery charge station is connected to the power source and defines a fourth battery compartment; a second battery is movable between a first position in which the second battery is received in the third battery compartment and electrically and mechanically coupled to the mobile base unit to provide power to the drive motor and the robotic arm and a second position in which the second battery is received in the fourth battery compartment and electrically and mechanically coupled to the second battery charge station to charge the second battery; and the controller is configured to: obtain a current power level of the second battery and move the second battery from the first position to the second position using the movable base in response to the current power level being less than the determined power level.

In yet another form, the present disclosure provides a system for charging electric vehicles that includes a rail structure, a mobile base unit, first and second battery charge stations, and first and second batteries. The mobile base unit is supported by the rail structure. The mobile base unit includes a movable base connected to the rail structure, a drive motor configured to move the movable base along the rail structure, and a robotic arm secured to the movable base. The first battery charge station is connected to a power source and supported by the rail structure. The first battery charge station is also spaced apart from the movable base. The second battery charge station is supported by the rail structure and spaced apart from the movable base. The second battery charge station is also connected to the power source. The first battery is movable by the movable base between a first position in which the first battery is electrically and mechanically coupled to the mobile base unit to provide power to the drive motor and the robotic arm, and a second position in which the first battery is electrically and mechanically coupled to the first battery charge station to charge the first battery. The second battery is movable by the movable base between a first position in which the second battery is electrically and mechanically coupled to the mobile base unit to provide power to the drive motor and the robotic arm, and a second position in which the second battery is electrically and mechanically coupled to the second battery charge station to charge the second battery. The movable base defines a first battery compartment and a second battery compartment opposite the first battery compartment. The first battery is received in the first battery compartment when the first battery is in the first position and the second battery is received in the second battery compartment when the second battery is in the first position. The first battery charge station defines a third battery compartment that is aligned with the first battery compartment and the second battery charge station defines a fourth battery compartment that is aligned with the second battery compartment. The first battery is received in the third battery compartment when the first battery is in the second position and the second battery is received in the fourth battery compartment when the second battery is in the second position. First guide members are disposed within the first battery compartment and configured to align and support the first battery within the first battery compartment. Second guide members are disposed within the second battery compartment and configured to align and support the second battery within the second battery compartment. Third guide members are disposed within the third battery compartment and configured to align and support the first battery within the third battery compartment. Fourth guide members are disposed within the fourth battery compartment and configured to align and support the second battery within the fourth battery compartment.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a functional block diagram of an example manufacturing environment in accordance with the teachings of the present disclosure;

FIG. 2A is a side view of a gantry system and a robot of the manufacturing environment of FIG. 1;

FIG. 2B is a side view of a portion of the gantry system of FIG. 1 with a robot arm in a resting state;

FIG. 2C is a side view of a portion of the gantry system of FIG. 1 with the robot arm in an operation state;

FIG. 3 is a close-up side view of a portion of the gantry system of FIG. 2;

FIG. 4 is an end view of the gantry system of FIG. 2;

FIG. 5 is a close-up side view of a portion of another gantry system that can be incorporated into the manufacturing environment of FIG. 1 in accordance with the teachings of the present disclosure;

FIG. 6 is a close-up side view of a portion of another gantry system that can be incorporated into the manufacturing environment of FIG. 1 in accordance with the teachings of the present disclosure;

FIG. 7 is a close-up view of a locking member of a movable base unit of the gantry system of FIG. 6 engaging a locking structure of a battery; and

FIG. 8 is a flowchart of an example control routine in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

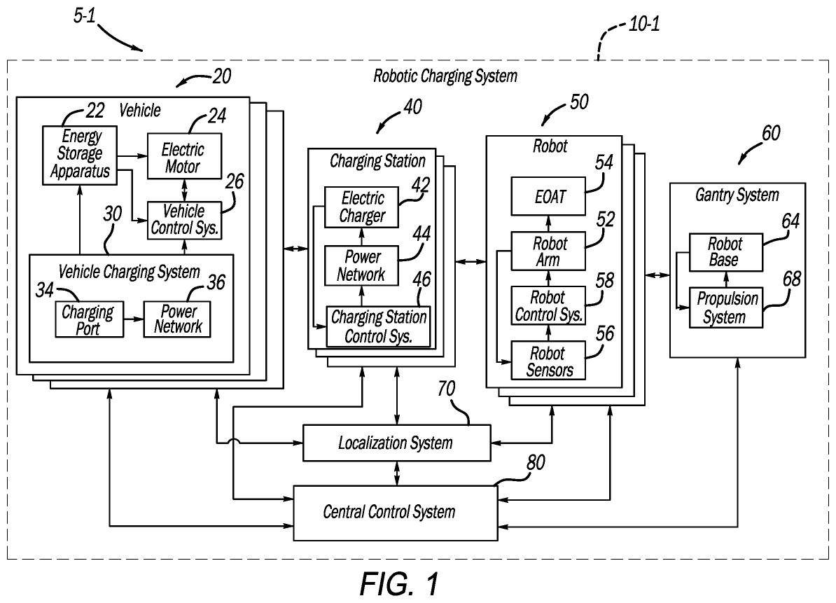

Referring to FIG. 1, a manufacturing environment 5-1 is shown and generally includes a robotic charging system 10-1. In one form, the robotic charging system 10-1 includes a plurality of vehicles 20, a plurality of charging stations 40, a plurality of robots 50, a gantry system 60, a localization system 70 and a central control system 80. It should be understood that any one of the modules of the vehicles 20, the charging stations 40, the robots 50, the gantry system 60, the localization system 70, and the central control system 80 can be provided at the same location or distributed at different locations (e.g., via one or more edge computing devices) and communicably coupled accordingly. In one form, the vehicles 20, the charging stations 40, the robots 50, the gantry system 60, the localization system 70, and the central control system 80 are communicably coupled using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

In one form, the vehicles 20 are electric vehicles. As used herein, “electric vehicle” refers to a vehicle that employs one or more electric motors for propulsion. Some examples of electric vehicles are battery electric vehicles (BEVs), hybrid electric vehicles (HEVs), plug-in electric vehicles (PHEVs), or fuel cell vehicles, for example. In one form, the vehicles 20 may be provided by autonomous or semi-autonomous vehicles that are configured to perform one or more known autonomous routines within the manufacturing environment 5-1, such as an autonomous navigation routine, a driver assistance routine, an adaptive cruise control routine, an autonomous braking routine, and/or an object detection routine. It should be understood that the vehicles 20 may be other types of vehicles and are not limited to the examples described herein.

In one form, the vehicles 20 may each include an electric motor 24 that employ electrical energy stored in an energy storage apparatus 22, such as one or more vehicle batteries, to perform one or more propulsion-based operations. In one form, the vehicles 20 include a vehicle control system 26 that is configured to control and/or monitor a particular system or subsystem of the vehicles 20. As an example, the vehicle control system 26 may include a propulsion control module for controlling the operation of the electric motor 24, among other vehicle modules. In one form, the electric motor 24, the energy storage apparatus 22, and the vehicle control system 26 are communicably coupled by a vehicle interface, such as a control system area network (CAN) bus, a local interconnect network (LIN) bus, and/or a clock extension peripheral interface (CXPI) bus.

In one form, the vehicles 20 may each include a vehicle charging system 30 that is configured to receive electrical energy from the charging stations 40. The vehicle charging system 30 may include a charging port cover (not shown), a charging port 34, and a power network 36. In one form, the charging port 34 provides an electrical interface for physically and electrically/inductively coupling an electrical charger of the charging station 40 to the power network 36. As an example, the charging port 34 is provided by a charging receptacle (e.g., an electrical outlet) that receives one or more conductive components of the electrical charger of the charging station 40. In one form, the power network 36 selectively adjusts one or more characteristics of the electric signal received from the charging stations 40 and provides the adjusted signal to the energy storage apparatus 22. As an example, the power network 34 includes an alternating current-alternating current (AC-AC) converter circuit that is configured to adjust an amplitude and/or frequency component of an AC electric signal, such as a voltage source inverter, a current source inverter, a cycloconverter, a matrix converter, among other AC-AC converter circuits. As another example, the power network 36 includes an AC-direct current (AC-DC) converter circuit that is configured to convert the AC electric signal into a DC electric signal, such as a rectifier circuit and/or other AC-DC converter circuits.

In one form, the charging stations 40 are configured to provide electrical energy to the vehicles 20 during a charging operation and include an electric charger or charging apparatus 42, a power converter network 44, and a charging station control system 46. In one form, the electric charger 42 is electrically coupled to a power grid via the power converter network 44 and may include a conductive cable (e.g., a Level 4 DC fast charger cable, a Level 3 DC charger cable, or a Level 2 AC charger cable) and a charging interface for physically and electrically/inductively coupling to the power network 36 via the charging port 34, such as a plug or a wireless charging pad. In one form, the power converter network 44 is configured to adjust one or more characteristics of the electrical power output by the grid and provide the adjusted electrical power to the energy storage apparatus 22 via the charging port 34 and the power network 36. As an example, the power network 44 may include similar circuits and converter networks as the power network 36, and as such, the description thereof is omitted for brevity.

In one form, each robot 50 includes a robot arm or robotic arm 52, an end of arm tool (EOAT) or end-effector 54, robot sensors 56, and a robot control system 58 configured to control the robotic arm 52 and the EOAT 54 to perform one or more automated tasks. Example automated tasks include, but are not limited to, retrieving the electric charger 42 from the charging station 40 and moving the electric charger 42 proximate to the vehicle 20 (e.g., the charging port 34), removing the charging port cover to insert the electric charger 42 into the charging port 34, among other automated tasks.

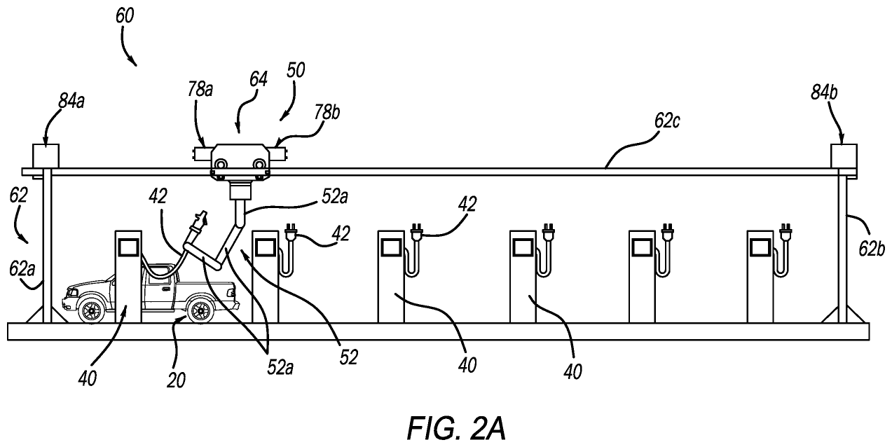

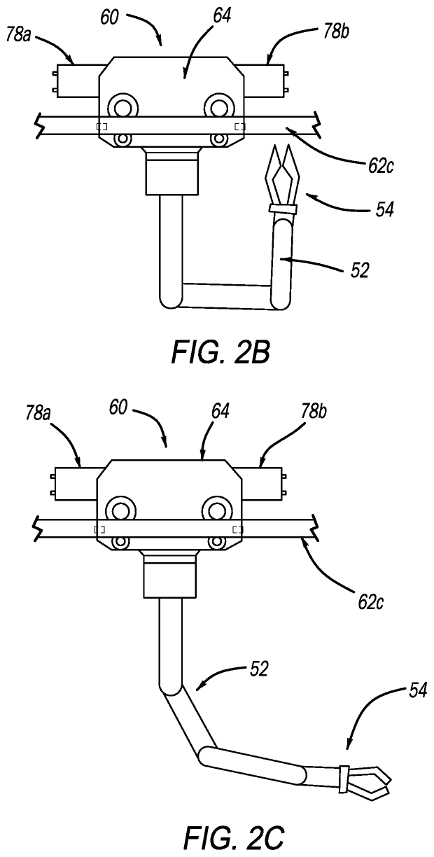

In one form, the robotic arm 52 includes a plurality of segments 52a (FIG. 2A) connected to each other at joints, thereby allowing the robotic arm 52 to have multiple degrees of freedom. One example of such robotic arm 52, the EOAT 54, and robot control system 58 are disclosed in U.S. patent application Ser. No. 18/177,954, and titled “ROBOTIC ARM ASSEMBLY FOR ELECTRIC VEHICLE CHARGER,” which is commonly owned with the present application and the contents of which are incorporated herein by reference in its entirety.

In one form, with reference to FIGS. 2A-2C, 3, and 4, the gantry system 60 includes a structural base assembly 62 (FIG. 2A), one or more robot bases or movable bases 64, and a drive or propulsion system 68 (FIGS. 1, 3, and 4). The structural base assembly 62 is secured to a ground surface and is configured to physically support the robot base 64. In one example, the structural base assembly 62 is permanently fixed to the ground surface. In another example, the structural base assembly 62 may include wheels that may be movable between a locked position to inhibit movement of the structural base assembly 62 in the manufacturing environment 5-1 and an unlocked position to permit movement of the structural base assembly 62 in the manufacturing environment 5-1. In the example illustrated, the structural base assembly 62 includes support legs 62a, 62b and a rail structure 62c. In the example illustrated, the support legs 62a, 62b are spaced apart from each other and extend in a vertical direction. Stated differently, the support leg 62a is disposed at a first end of the gantry system 60 and the support leg 62b is disposed at a second end of the gantry system 60 that is opposite the first end.

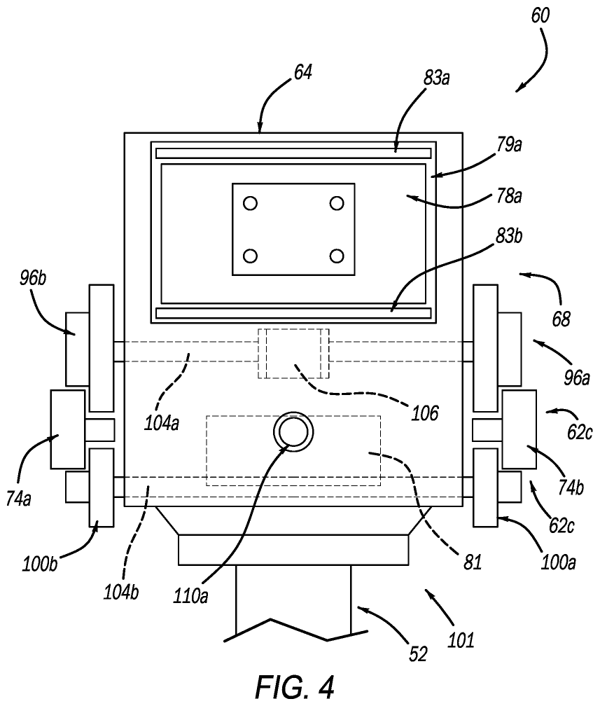

The rail structure 62c extends in a horizontal direction and is secured to upper ends of the support legs 62a, 62b. In this way, the rail structure 62c is located above the charging stations 40 and the vehicles 20 located at the charging stations 40. In some forms, the rail structure 62c may be secured to the support legs 62a, 62b at a location that is between the upper ends of the support legs 62a, 62b and lower ends of the support legs 62a, 62b (i.e., the lower ends of the support legs 62a, 62b are secured to the ground surface). In this way, the rail structure 62c may be positioned below the charging stations 40, for example. In the example illustrated, the rail structure 62c includes a pair of spaced apart rails 74a, 74b (FIG. 4) that extend along a longitudinal direction of the structural base assembly 62. In one variation, the support legs 62a, 62b of the structural base assembly 62 may be omitted such that the structural base assembly 62 includes only the rail structure 62c. In such variation, the rail structure 62c is secured to a ceiling, wall, or other beam of the manufacturing environment 5-1.

Each robot base 64 is connected to the rail structure 62c and connected to an end of a respective robotic arm 52, and is configured to move along the rail structure 62c between the charging stations 40. In this way, the robot 50 can initiate the charging operation at any one of the charging stations 40. In the example illustrated, the robot base 64 is connected to the rail structure 62c such that the robot base 64 and the respective robotic arm 52 are suspended therefrom above the ground surface. In the example illustrated, the robot base 64 is connected to the rail structure 62c by the drive system 68, which is described in more detail below.

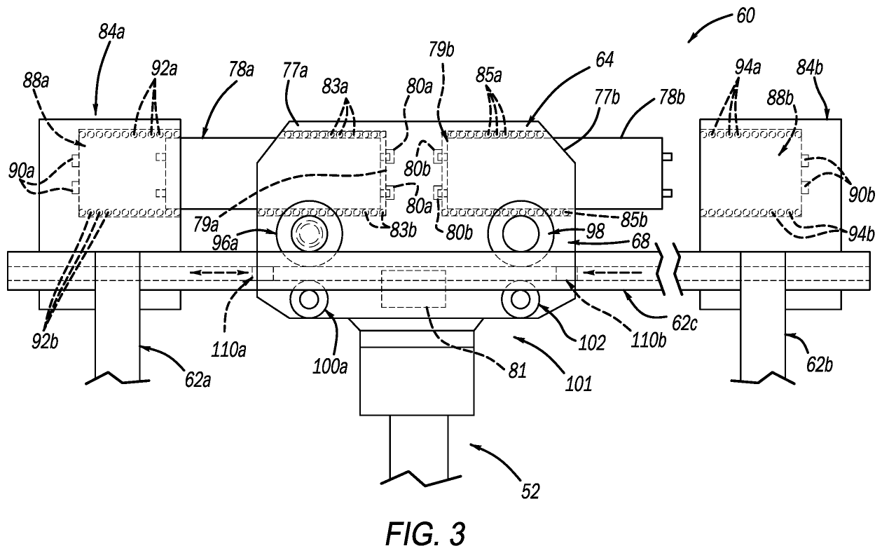

The robot base 64 and the robotic arm 52 are powered by a battery 78a, 78b such as a rechargeable battery, for example. With reference to FIG. 3, each robot base 64 includes a first end 77a that defines a battery compartment 79a and a second end 77b that is opposite the first end 77a and that defines a battery compartment 79b. The battery compartment 79a is configured to at least partially receive the battery 78a and the battery compartment 79b is configured to at least partially receive the battery 78b. The first end 77a faces the support leg 62a and the second end 77b faces the support leg 62b. In some forms, the battery compartment 79a may receive at least half of the battery 78a and the battery compartment 79b may receive at least half of the battery 78b. In the example illustrated, the battery compartments 79a, 79b are horizontally aligned with each other. In some forms, the battery compartments 79a, 79b may be horizontally offset from each other. First electrical terminals 80a is located within the battery compartment 79a and second electrical terminals 80b is located within the battery compartment 79b. The electrical terminals 80a provide an electrical interface for physically and electrically/inductively coupling battery 78a to the robot base 64 and robot arm 52. Similarly, the electrical terminals 80b provides an electrical interface for physically and electrically/inductively coupling battery 78b to the robot base 64 and the robot arm 52. In this way, the batteries 78a, 78b are configured to be electrically coupled to the electrical terminals 80a, 80b to power the robot base 64 and the robotic arm 52.

In the example illustrated, the robot base 64 may optionally include a rechargeable back-up battery 81. The back-up battery 81 may operate to power the robot base 64 and the robotic arm 52. In one example, the back-up battery 81 may operate to power the robot base 64 to move along the rail structure 62c in the event that the power or charge level of one or both of the batteries 78a, 78b are below a predetermined threshold. The power capacity of the rechargeable back-up battery 81 may be such that it can power the robot base 64 to move along the track from the support leg 62a to the support leg 62b and back to the support leg 62a, for example. In some forms, when the robot base 64 picks up a charged battery 78a, 78b from a battery charging station or battery charge station 84a, 84b, the charged battery 78a, 78b provides power to the back-up battery 81 such that the back-up battery 81 is charged to a predetermined threshold (e.g., the charged battery 78a, 78b provides power to the back-up battery 81 such that it is fully charged or at least 70% of a fully charged state). The robot base 64 and the robot arm 52 form a mobile base unit 101.

Guide members 83a, 83b are disposed within the battery compartment 79a and are configured support the battery 78a within the battery compartment 79a. The guide members 83a, 83b are also configured to align the battery 78a with the first electrical terminal 80a within the battery compartment 79a. The guide members 83a are located at an upper portion of the battery compartment 79a and are configured to engage an upper portion of the battery 78a within the battery compartment 79a. Similarly, the guide members 83b are located at a lower portion of the battery compartment 79a and are configured to engage a lower portion of the battery 78a within the battery compartment 79a.

Guide members 85a, 85b are disposed within the battery compartment 79b and are configured to support the battery 78b within the battery compartment 79b. The guide members 83a, 83b are also configured to align the battery 78b with the second electrical terminal 80b within the battery compartment 79b. The guide members 85a are located at an upper portion of the battery compartment 79b and are configured to engage an upper portion of the battery 78b within the battery compartment 79b. Similarly, the guide members 85b are located at a lower portion of the battery compartment 79b and are configured to engage a lower portion of the battery 78b within the battery compartment 79b. In the example illustrated, each of the guide members 83a, 83b, 85a, 85b may include a series of rollers that are rotatably secured to the robot base 64 and facilitate transport of the battery 78a, 78b with the battery compartment 79a, 79b.

In the example illustrated, the battery charging station 84a is disposed proximate the support leg 62a of the gantry system 60 and is configured to recharge the battery 78a. The battery charging station 84a is powered by solar panels (not shown) associated with the manufacturing environment 5-1, a swappable battery pack, and/or the power grid. In the example illustrated, the battery charging station 84a may be secured to and supported by one or both of the support leg 62a and the rail structure 62c. In some forms, the battery charging station 84a may be secured to and supported by an awning or cover (not shown) attached to and covering the gantry system 60.

With reference to FIG. 3, the battery charging station 84a defines a battery compartment 88a that is configured to at least partially receive the battery 78a. That is, in some forms, the battery compartment 88a may receive at least half of the battery 78a. In the example illustrated, the battery compartment 88a is horizontally aligned with the battery compartment 79a of the robot base 64. Electrical terminals 90a are located within the battery compartment 88a and provides an electrical interface for physically and electrically/inductively coupling the battery 78a to the battery charging station 84a. That is, the battery 78a is configured to be electrically coupled to the battery charging station 84a to charge the battery 78a.

The battery charging station 84b is disposed proximate the support leg 62b of the gantry system 60 and is configured to recharge the battery 78b. The battery charging station 84b is powered by solar panels (not shown) associated with the manufacturing environment 5-1, a swappable battery pack, and/or the power grid. In the example illustrated, the battery charging station 84b may be secured to and supported by one or both of the support leg 62b and the rail structure 62c. In some forms, the battery charging station 84b may be secured to and supported by the awning or cover (not shown) attached to and covering the gantry system 60.

The battery charging station 84b defines a battery compartment 88b that is configured to at least partially receive the battery 78b. That is, in some forms, the battery compartment 88b may receive at least half of the battery 78b. In the example illustrated, the battery compartment 88b is horizontally aligned with the battery compartment 79b of the robot base 64. Electrical terminals 90b are located within the battery compartment 88b and provides an electrical interface for physically and electrically/inductively coupling the battery 78b to the battery charging station 84b. That is, the battery 78b is configured to be electrically coupled to the battery charging station 84b to charge the battery 78b. Each robot base 64 is disposed between the battery charging station 84a and the battery charging station 84b.

Guide members 92a, 92b are disposed within the battery compartment 88a and are configured to support the battery 78a within the battery compartment 88a. The guide members 92a, 92b are also configured to align the battery 78a with the electrical terminal 90a within the battery compartment 88a. The guide members 92a are located at an upper portion of the battery compartment 88a and are configured to engage an upper portion of the battery 78a within the battery compartment 88a. Similarly, the guide members 92b are located at a lower portion of the battery compartment 88a and are configured to engage a lower portion of the battery 78a within the battery compartment 88a.

Guide members 94a, 94b are disposed within the battery compartment 88b and are configured to support the battery 78b within the battery compartment 88b. The guide members 94a, 94b are also configured to align the battery 78b with the first electrical terminal 90b within the battery compartment 88b. The guide members 94a are located at an upper portion of the battery compartment 88b and are configured to engage an upper portion of the battery 78b within the battery compartment 88b. Similarly, the guide members 94b are located at a lower portion of the battery compartment 88b and are configured to engage a lower portion of the battery 78b within the battery compartment 88b. In the example illustrated, each of the guide members 92a, 92b may include a series of rollers that are rotatably secured to the battery charge station 84a and facilitates transport of the battery 78a within the battery compartment 88a. Similarly, guide members 94a, 94b may include a series of rollers that are rotatably secured to the battery charge station 84b and facilitates transport of the battery 78b with the battery compartment 88b.

With reference to FIGS. 3 and 4, in one form, the propulsion system 68 is associated with a respective robot base 64 and includes various components for powering the robot base 64 and the robotic arm 52. In the example illustrated, the propulsion system 68 includes a pair of drive or primary wheels 96a, 96b, a pair of secondary wheels 98 (only one shown in the figures), a first pair of stabilizing wheels 100a, 100b, a second pair of stabilizing wheels 102 (only one shown in the figures), a plurality of shafts 104a, 104b, and a motor 106 (FIG. 4). The primary wheels 96a, 96b are connected to each other via shaft 104a that extends in a transverse direction through robot base 64 (i.e., the transverse direction is perpendicular to a longitudinal direction of the rail structure 62c). In this way, rotation of the shaft 104a causes corresponding rotation of the primary wheels 96a, 96b. One primary wheel 96a engages an upper portion of rail 74b and is configured to roll along the upper portion of rail 74b. Similarly, the other primary wheel 96b engages an upper portion of rail 74a and is configured to roll along the upper portion of rail 74a. The secondary wheels 98 may optionally be connected to each other via a shaft (not shown) that extends in the transverse direction through the robot base 64. In this way, the secondary wheels 98 and the shaft can be fixed for rotation with each other. The secondary wheels 98 engage the rail structure 62c and are configured to roll along the upper portion of rail structure 62c. In the example illustrated, the primary wheels 96a, 96b and the secondary wheels 98 have the same diameter. In some forms, the primary wheels 96a, 96b and the secondary wheels 98 have different diameters. In the example provided, the secondary wheels 98 are not driven wheels. In an alternative form, not specifically shown, the secondary wheels 98 may be driven by the motor 106 or another motor.

The first pair of stabilizing wheels 100a, 100b may optionally be connected to each other via shaft 104b (FIG. 4) that extends in the transverse direction through the robot base 64. In this way, the first pair of stabilizing wheels 100a, 100b and the shaft 104b can be fixed for rotation with each other. The wheel 100a engages a lower portion of rail 74b and is configured to roll along the lower portion of rail 74b, and the wheel 100b engages a lower portion of rail 74a and is configured to roll along the lower portion of rail 74a. The second pair of stabilizing wheels 102 may optionally be connected to each other via a shaft (not shown) that extends in the transverse direction through the robot base 64. In this way, the second pair of stabilizing wheels 102 and the shaft can be fixed for rotation with each other. The wheels 102 engage the rail structure 62c and are configured to roll along the lower portion of the rail structure 62c. The wheels 96a, 96b, 98a, 100a, 100b, and 102a are configured to engage the rail structure 62c and stabilize the robot base 64 on the rail structure 62c especially when the robot arm 52 is performing an automated task as described above, for example. In the example illustrated, the first and second stabilizing wheels 100a, 100b, 102a, 102b have the same diameter, which is smaller than the diameter of the primary and secondary wheels 96, 98a, 98b. In some forms, the first stabilizing wheels 100a, 100b may have a diameter that is different from the second stabilizing wheels 102a, 102b.

In the example illustrated, the motor 106 is operatively engaged with the shaft 104a and is configured to rotate the shaft 104a, which causes corresponding rotation of the primary wheels 96a, 96b. Rotation of the wheels 96a, 96b causes corresponding movement of the robot base 64 along the rails 74a, 74b. In the example illustrated, the motor 106 is an electric motor. In some forms, the motor 106 may be a hydraulic motor or any other suitable motor that moves the robot base 64 along the rails 74a, 74b.

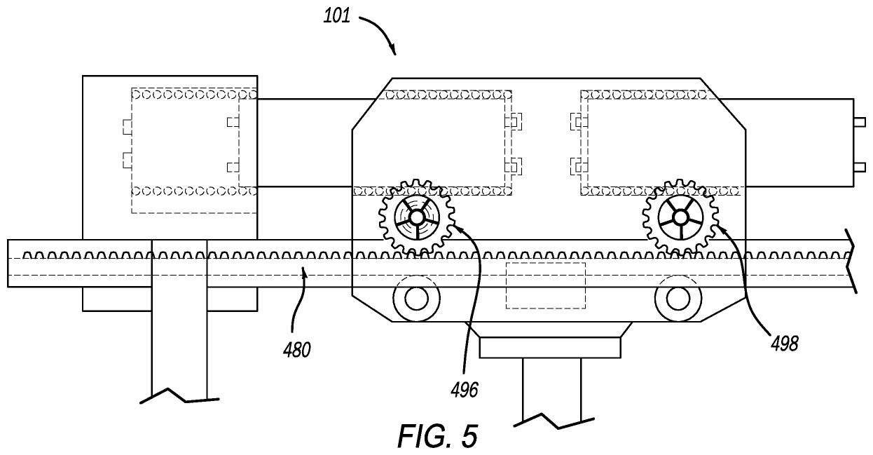

With reference to FIG. 5, in another form, a pair of first gears 496 (only one shown in the figure; also referred to herein as gear wheels) may be connected to each other via shaft 104a instead of drive wheels 96a, 96b and a pair of second gears 498 (only one shown in the figure; also referred to herein as gear wheels) may be connected to each other via a shaft (not shown) instead of secondary wheels 98. The first and second gears 496, 498 may be engaged with a gear rack 480 secured to an upper portion of rail structure 62c such that the first and second gears 496, 498 may traverse the gear rack 480 to move the mobile base unit 101 along the rail structure 62c. In this form, the motor 106 driving shaft 104a may include an encoder such that the position of the mobile base unit 101 along the rail structure 62c may be determined based on rotation of the motor 106.

One battery 78a, 78b is being charged while the other battery 78a, 78b is providing power to the motor 106. In this way, when the battery 78a, 78b providing power to the motor 106 is below a predetermined threshold needed to perform a charge request as described in more detail below, the robot base 64 may swap out batteries such that the robot base 64 can continue the charge request. In one form, the robot base 64 may load (i.e., pick-up) the charged battery 78a, 78b before unloading (docking or dropping off) the partially drained battery 78a, 78b. In some forms, the robot base 64 may unload the partially drained battery 78a, 78b before loading the charged battery 78a, 78b.

In one form, the localization system 70 (FIG. 1) is configured to localize the robots 50 relative to the vehicles 20 and/or the vehicles 20 relative to the robots 50. That is, the localization system 70 is configured to convert a robot-based position of the robot 50 to a vehicle-based position of the robot 50, a vehicle-based position of the vehicle 20 to a robot-based position of the vehicle 20, or a combination thereof. As an example, the localization system 70 may employ known imaging and fiducial marker systems that employ predefined robot/vehicle location coordinates and translation routines for localizing the robots 50 relative to the vehicles 20 and/or the vehicles 20 relative to the robots 50. As another example, the localization system 70 may employ known object detection systems having predefined robot/vehicle location coordinates and translation routines for localizing the robots 50 relative to the vehicles 20 and/or the vehicles 20 relative to the robots 50, such as a localization structure.

In one example, sensors 110a, 110b can be secured to the robot base 64 and each can be configured to measure a distance between the robot base 64 and a respective battery charge station 84a, 84b. That is, in the example illustrated, sensor 110a is secured to the first end 77a of the robot base 64 and is configured to measure the distance between the robot base 64 and the battery charge station 84a. Similarly, sensor 110b is secured to the second end 77b of the robot base 64 and is configured to measure the distance between the robot base 64 and the battery charge station 84b. The measured distances between the sensors 110a, 110b and the battery charge stations 84a, 84b are communicated to the central control system 80 (FIG. 1) and used in the localization of the robots 50 to the vehicles 20 and/or the vehicles 20 relative to the robots 50. In some forms, one sensor may be secured to the robot base 64 and configured to measure a distance between the robot base 64 and a respective charge station 84a, 84b instead of two sensors. In one example, each sensor 110a, 110b may be a laser range finder that uses a laser beam to measure the distance between the robot base 64 and the respective battery charge station 84a, 84b.

In one form, the central control system 80 (FIG. 1) is configured to control the operation of the robotic charging system 10-1. As an example, the central control system 80 obtains robot data associated with the robots 50, vehicle data associated with the vehicles 20, charging station data associated with the charging stations 40, and battery data associated with the batteries 78a, 78b. Furthermore, the central control system 80 determines whether one of the vehicles 20 has an amount of electrical energy stored in the corresponding energy storage apparatus 22 that is less than a threshold amount and instructs a selected robot 50 via the robot control system 58 to perform the charging operation. Furthermore, the central control system 80 may determine whether the battery 78a, 78b powering a selected robot base 64 has enough power to move the robot base 64 along the rail structure 62c in accordance with a desired charging sequence and move the robot 50 to perform one or more automated task.

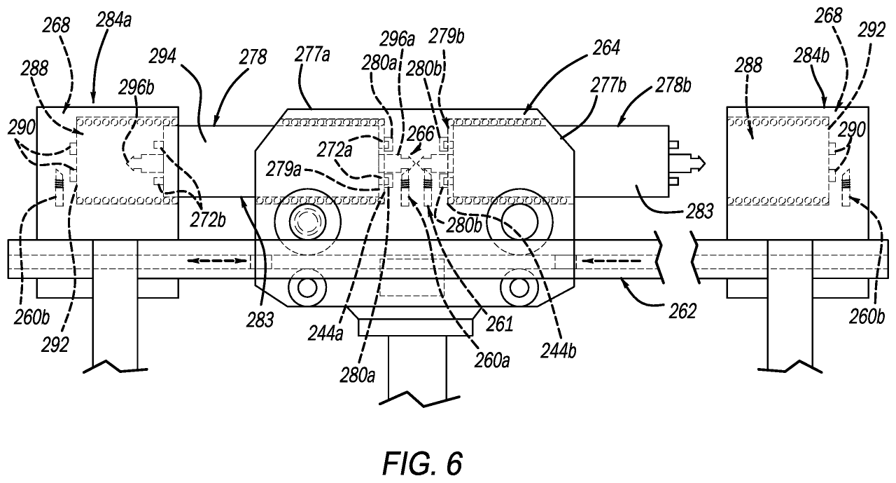

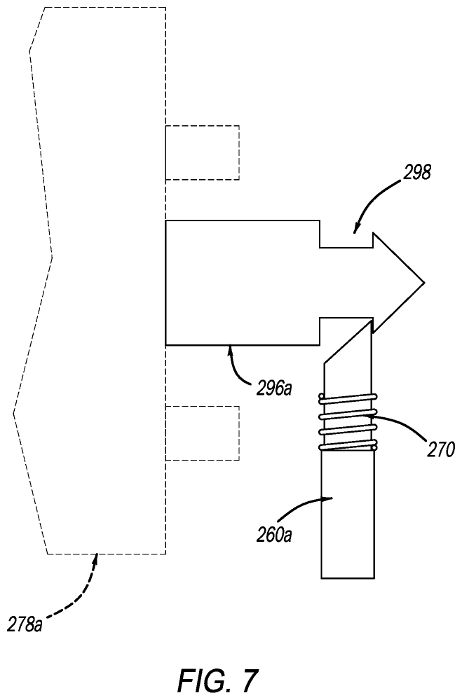

With reference to FIGS. 6 and 7, another robot base 264, batteries 278a, 278b, and battery charge stations 284a, 284b are provided. The robot base 264, the batteries 278a, 278b, and the battery charge stations 284a, 284b may be incorporated into the robotic charging system 10-1 described above instead of the robot base 64, the batteries 78a, 78b and the battery charge stations 84a, 84b described above.

The structure and function of the robot base 264 may be similar or identical to that of the robot base 64 described above, apart from any exceptions noted below. The robot base 264 includes a first end 277a that defines a first battery compartment 279a and a second end 277b that is opposite the first end 277a and that defines a second battery compartment 279b. Each battery compartment 279a, 279b is configured to at least partially receive a respective battery 278a, 278b. First electrical terminals 280a are located within the battery compartment 279a along a back wall 244a defining the battery compartment 279a and second electrical terminals 280b are located within the battery compartment 279b along a back wall 244b defining the battery compartment 279b. The electrical terminals 280a provide an electrical interface for physically and electrically/inductively coupling the battery 278a located within the battery compartment 279a to the drive motor. Similarly, the electrical terminals 280b provide an electrical interface for physically and electrically/inductively coupling the battery 278b located within the battery compartment 279b to the drive motor.

The structure and function of each battery charge station 284a, 284b may be similar or identical to that of the battery charge stations 84a, 84b described above, apart from any exceptions noted below. Each battery charge station 284a, 284b defines a battery compartment 288 that is configured to at least partially receive a respective battery 278a, 278b. Electrical terminals 290 is located within the battery compartment 288 along a back wall 292 defining the battery compartment 288 and provides an electrical interface for physically and electrically/inductively coupling the respective battery 278a, 278b to the battery charging station 284a, 284b for charging the respective battery 278a, 278b.

The structure and function of each battery 278a, 278b may be similar or identical to that of the batteries 78a, 78b described above, apart from any exceptions noted below. Each battery 278a, 278b is configured to power the drive motor to move the robot base 264 along the rail structure 262 and powers the robot arm 252 to perform one or more automated tasks as described above. Each battery 278a, 278b includes an enclosure 283 which provides a structural surrounding and sealed compartment for one or more battery arrays (not shown) disposed therein. The battery arrays may be rechargeable and may include lithium-ion batteries or any other suitable electrical power storage units.

The enclosure 283 includes a body 294 and a pair of locking members 296a, 296b. The locking member 296a extends from a first end of the body 294 towards the robot base 264 and the locking member 296b extends from a second end of the body 294 that is opposite the first end towards battery charge station 284a, 284b. Each locking member 296a, 296b has an arrow shape and defines an annular groove or slot 298 (FIG. 7) that is configured to receive or engage a locking structure 260a, 260b to lock the battery 278a, 278b to the robot base 264 and the battery charge station 284a, 284b.

In the example illustrated, the locking structure 260a is disposed within the robot base 264 in a cavity 266 between the battery compartments 279a, 279b. When the battery 278a is electrically coupled to the robot base 264 (i.e., first electrical terminals 272a of the battery 278 are electrically coupled with the first electrical terminals 280a of the robot base 264), the locking structure 260a is movable between a disengaged position in which the locking structure 260a is disengaged from the locking member 296a of the battery 278a located within the battery compartment 279a and an engaged position (FIGS. 6 and 7) in which the locking structure 260a is engaged with the locking member 296a of the battery 278a located within the battery compartment 279a. When the locking structure 260a is in the disengaged position, the battery 278a is allowed to move within the battery compartment 279a. When the locking structure 260a is in the engaged position, the battery 278a is inhibited from moving within the battery compartment 279a. It should be understood that when the battery 278a is electrically coupled to the robot base 264, the locking structure 260a extends through an opening in the back wall 244a of the battery compartment 279a into the cavity 266 of the robot base 264.

In the example illustrated, the locking structure 260b is disposed within a respective battery charge station 284a, 284b in a cavity 268 adjacent the battery compartment 288. When the battery 278a is electrically coupled to the battery charge station 284a (i.e., second electrical terminals 272b of the battery 278a are electrically coupled with the electrical terminals 290 of the battery charge station 284a, 284b), the locking structure 260b is movable between a disengaged position in which the locking structure 260b is disengaged from the locking member 296b of the battery 278a located within the battery compartment 288, and an engaged position in which the locking structure 260b is engaged with the locking member 296b of the battery 278a located within the battery compartment 288. When the locking structure 260b is in the disengaged position, the battery 278a is allowed to move within the battery compartment 288. When the locking structure 260b is in the engaged position, the battery 278a is inhibit from moving within the battery compartment 288. It should be understood that when the battery 278a is electrically coupled to the battery charge station 284a, the locking structure 260b extends through an opening in the back wall 292 of the battery compartment 288 into the cavity 268 of the battery charge station 284a. In the example illustrated, each locking structure 260a, 260b is a spring loaded pin that may be movable between the disengaged position and the engage position by a respective solenoid 270 operable by the central control system 80. The battery 278b configured to be received in the battery compartment 279b maybe locked and unlocked relative to the robot base 264 by a locking structure 261 similar or identical locking structure 260a, and therefore, will not be described in detail.

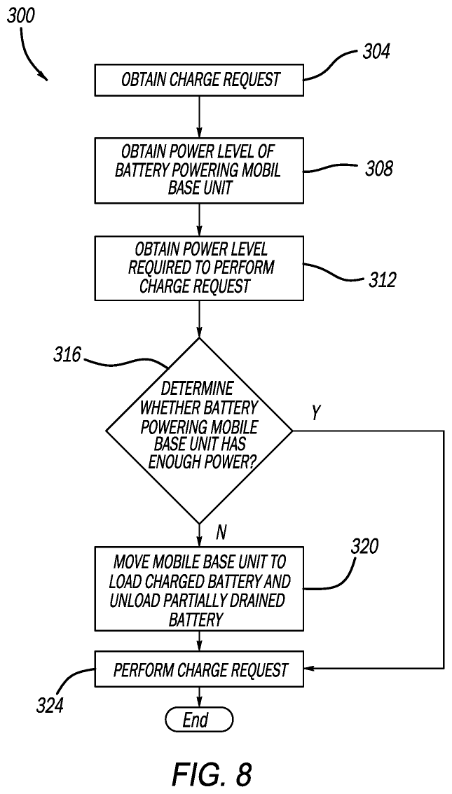

Referring to FIG. 8, an example control algorithm 300 for swapping the batteries 78a, 78b between the mobile base unit 101 and the battery charge stations 84a, 84b is illustrated. The processing may begin at 304 when the control algorithm, using the central control system 80, obtains a charge request from one or more vehicles 20 requiring charging. That is, one or more vehicles 20 may send a charge request to the central control system 80 once a current state of charge (SOC) level of the energy storage apparatus 22 falls below a predetermined threshold SOC level. In one example, the predetermined threshold SOC level may be 60% of a fully charged state. In another example, the predetermined threshold SOC level may be 70% of a fully charged state. At 308, the control algorithm, using the central control system 80, obtains the power level of the battery 78a, 78b powering the drive motor 106 of the mobile base unit 101. That is, in one example, one of the batteries 78a, 78b is electrically coupled to the mobile base unit 101 as described above to power the drive motor 106 of the mobile base unit 101 and the other battery 78a, 78b is docked at the respective battery charging station 84a, 84b for charging.

At 312, the control algorithm, using the central control system 80, obtains the power level required to perform the charge request. At 316, the control algorithm, using the central control system 80, determines whether the battery 78a, 78b powering the mobile base unit 101 has enough power to perform the charge request based on the power level of the battery 78a, 78b and the determined power level required to perform the charge request. If the battery 78a, 78b powering the mobile base unit 101 does not have enough power to perform the charge request, the control algorithm proceeds to 320; otherwise, the control algorithm proceeds to 324.

At 320, the control algorithm, using the mobile base unit 101, moves the charged battery 78a, 78b from the respective charge station 84a, 84b onto the mobile base unit 101 and moves the partially drained battery 78a, 78b from the mobile base unit 101 to the respective charge station 84a, 84b. It should be understood that moving the charged battery 78a, 78b from the respective charge station 84a, 84b onto the mobile base unit 101 includes electrically and mechanically decoupling the charged battery 78a, 78b from the respective charge station 84a, 84b and electrically and mechanically coupling the charged battery 78a, 78b to the mobile base unit 101 as described above. Similarly, it should be understood that moving the partially drained battery 78a, 78b from the mobile base unit 101 to the respective charge station 84a, 84b includes electrically and mechanically decoupling the partially drained battery 78a, 78b from the mobile base unit 101 and electrically and mechanically coupling the partially drained battery 78a, 78b to the respective charge station 84a, 84b as described above. In one example, with reference to FIGS. 2B and 2C, the robot arm 52 is in a resting state (FIG. 2B) when the robot base 64 traverses the rail structure 62c, and in an operational state (FIG. 2C) when the robot base 64 is performing an automated task as described above. In this way, when in the resting state, the robot arm 52 is folded up to a minimum envelope for ease of transportation along the rail structure 62c.

In the event that the battery 78a, 78b powering the mobile base unit 101 is below a power level required to load the charged battery 78a, 78b (i.e., cannot move the mobile base unit 101 along the rail structure 62c such that the mobile base unit 101 is allowed to move the charged battery 78a, 78b from the charge station 84a, 84b onto the mobile base unit 101), the rechargeable back-up battery 81 may power the drive motor 106 of the mobile base unit 101 such that the mobile base unit 101 is allowed to move along the rail structure 62c to load the charged battery 78a, 78b onto the mobile base unit 101. At 324, the control algorithm, using the central control system 80, performs the charge request, thereby charging one or more vehicles 20.

If the robot base 264, batteries 278a, 278b, and the battery charge stations 284a, 284b are provided instead of the robot base 64, the batteries 78a, 78b and the battery charge stations 84a, 84b described above, then the following steps are performed for loading the charged battery 278a and unloading the partially drained battery 278b. It should be understood that the steps will be similar or identical for loading the charged battery 278b and unloading partially drained battery 278a. Regarding loading the charged battery 278a from the battery charge station 284a to the mobile base unit 101, first, the mobile base unit 101 moves toward the battery charge station 284a such that the charged battery 278a docked on the battery charge station 284a is received in the battery compartment 279a of the robot base 264 and the mobile base unit 101 is electrically coupled with the battery 278a. Next, the locking structure 260a is moved from the disengaged position to the engaged position such that the charged battery 278a is secured to the mobile base unit 101. Next, the locking structure 260b is moved from the engaged position to the disengaged position such that the charged battery 278a is decoupled from the battery charge station 284a.

Regarding unloading the partially drained battery 278b from the mobile base unit 101 to the battery charged station 284b, first, the mobile base unit 101 moves toward the battery charge station 284b such that the partially drained battery 278b is received in the battery compartment 288 of the battery charge station 284b and electrically coupled to the battery charge station 284b. Next, the locking structure 260b is moved from the disengaged position to the engaged position such that the partially drained battery 278b is secured to the battery charge station 284b. Next, the locking structure 261 is moved from the engaged position to the disengaged position such that the partially drained battery 278b is decoupled from the mobile base unit 101.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for charging electric vehicles, the system comprising:
a rail structure;
a mobile base unit supported by the rail structure, the mobile base unit including a movable base connected to the rail structure, a drive motor configured to move the movable base along the rail structure, and a robotic arm secured to the movable base, the movable base defining a first battery compartment;
a first battery charge station connected to a power source and defining a second battery compartment; and
a first battery movable between a first position in which the first battery is received in the first battery compartment and electrically and mechanically coupled to the mobile base unit to provide power to the drive motor and the robotic arm, and a second position in which the first battery is received in the second battery compartment and electrically and mechanically coupled to the first battery charge station to charge the first battery,
wherein the movable base moves the first battery from the first position to the second position.

2. The system of claim 1, wherein the first battery compartment is horizontally aligned with the second battery compartment.

3. The system of claim 1, wherein the robotic arm hangs below the movable base.

4. The system of claim 1, further comprising:
first and second guide members disposed within the first battery compartment and configured to align and support the first battery within the first battery compartment, the first guide members located at an upper portion of the first battery compartment and the second guide members located at a lower portion of the first battery compartment; and
third and fourth guide members disposed within the second battery compartment and configured to align and support the first battery within the second battery compartment, the third guide members located at an upper portion of the second battery compartment and the fourth guide members located at a lower portion of the second battery compartment.

5. The system of claim 1, further comprising:
the movable base defining a third battery compartment opposite the first battery compartment;
a second battery charge station spaced apart from the movable base, the second battery charge station connected to the power source and defining a fourth battery compartment; and
a second battery movable between a first position in which the second battery is received in the third battery compartment and electrically and mechanically coupled to the mobile base unit to provide power to the drive motor and the robotic arm, and a second position in which the second battery is received in the fourth battery compartment and electrically and mechanically coupled to the second battery charge station to charge the second battery.

6. The system of claim 5, wherein the first battery charge station is located at a first end of the rail structure and the second battery charge station is located at a second end of the rail structure that is opposite the first end.

7. The system of claim 1, wherein the first battery includes a body and first and second locking members, the first locking member extends from a first end of the body toward the first battery charge station and the second locking member extends from a second opposite end of the body toward the mobile base unit.

8. The system of claim 7, further comprising:
a first locking pin at least partially disposed within the first battery charge station and movable between a first position in which the first locking pin is disengaged from the first locking member to allow the first battery to move within the second battery compartment and a second position in which the first locking pin is engaged with the first locking member to inhibit the first battery to move within the second battery compartment; and
a second locking pin at least partially disposed within the movable base and movable between a first position in which the second locking pin is disengaged from the second locking member to allow the first battery to move within the first battery compartment and a second position in which the second locking pin is engaged with the second locking member to inhibit the first battery to move within the first battery compartment.

9. The system of claim 8, wherein the first and second locking pins are spring loaded locking pins.

10. The system of claim 1, wherein the robot arm includes a plurality of segments connected to each other such that the robot arm has multiple degrees of freedom.

11. The system of claim 1, further comprising a sensor configured to measure a distance between the first battery charge station and the mobile base unit.

12. The system of claim 1, wherein the movable base is connected to the rail structure by a gear assembly including gear wheels.

13. A system for charging a plurality of electric vehicles, the system comprising:
a rail structure;
a mobile base unit supported by the rail structure, the mobile base unit including a movable base connected to the rail structure, a drive motor configured to move the movable base along the rail structure, and a robotic arm secured to the movable base;
a first battery charge station connected to a power source and aligned with the movable base; and
a first battery movable between a first position in which the first battery is electrically and mechanically coupled to the mobile base unit to provide power to the drive motor and the robotic arm, and a second position in which the first battery is electrically and mechanically coupled to the first battery charge station to charge the first battery; and
a controller configured to:
obtain a charge request from one or more electric vehicles;
obtain a current power level of the first battery;
determine a power level required to perform the charge request; and
move the first battery from the first position to the second position using the movable base in response to the current power level being less than the determined power level.

14. The system of claim 13, further comprising a sensor configured to measure a distance between the first battery charge station and the mobile base unit.

15. The system of claim 14, wherein the robotic arm hangs below the movable base.

16. The system of claim 13, wherein:
the movable base defines a first battery compartment, the first battery is received in the first battery compartment when the first battery is in the first position; and
the first battery charge station defines a second battery compartment that is aligned with the first battery compartment, the first battery is received in the second battery compartment when the first battery is in the second position.

17. The system of claim 16, further comprising:
first and second guide members disposed within the first battery compartment and configured to align and support the first battery within the first battery compartment, the first guide members located at an upper portion of the first battery compartment and the second guide members located at a lower portion of the first battery compartment; and
third and fourth guide members disposed within the second battery compartment and configured to align and support the first battery within the second battery compartment, the third guide members located at an upper portion of the second battery compartment and the fourth guide members located at a lower portion of the second battery compartment.

18. The system of claim 16, further comprising:
the movable base defining a third battery compartment opposite the first battery compartment;
a second battery charge station aligned with the movable base, the second battery charge station connected to the power source and defining a fourth battery compartment; and
a second battery movable between a first position in which the second battery is received in the third battery compartment and electrically and mechanically coupled to the mobile base unit to provide power to the drive motor and the robotic arm and a second position in which the second battery is received in the fourth battery compartment and electrically and mechanically coupled to the second battery charge station to charge the second battery.

19. The system of claim 18, wherein the controller is configured to:
obtain a current power level of the second battery; and
move the second battery from the first position to the second position using the movable base in response to the current power level being less than the determined power level.

20. A system for charging a plurality of electric vehicles, the system comprising:
a rail structure;
a mobile base unit supported by the rail structure, the mobile base unit including a movable base connected to the rail structure, a drive motor configured to move the movable base along the rail structure, and a robotic arm secured to the movable base;
a first battery charge station connected to a power source and supported by the rail structure, the first battery charge station also spaced apart from the movable base;
a second battery charge station supported by the rail structure and spaced apart from the movable base, the second battery charge station also connected to the power source;
a first battery movable by the movable base between a first position in which the first battery is electrically and mechanically coupled to the mobile base unit to provide power to the drive motor and the robotic arm, and a second position in which the first battery is electrically and mechanically coupled to the first battery charge station to charge the first battery; and
a second battery movable by the movable base between a first position in which the second battery is electrically and mechanically coupled to the mobile base unit to provide power to the drive motor and the robotic arm, and a second position in which the second battery is electrically and mechanically coupled to the second battery charge station to charge the second battery,
wherein:
the movable base defines a first battery compartment and a second battery compartment opposite the first battery compartment, the first battery is received in the first battery compartment when the first battery is in the first position and the second battery is received in the second battery compartment when the second battery is in the first position, and
the first battery charge station defines a third battery compartment that is aligned with the first battery compartment and the second battery charge station defines a fourth battery compartment that is aligned with the second battery compartment, the first battery is received in the third battery compartment when the first battery is in the second position and the second battery is received in the fourth battery compartment when the second battery is in the second position,
first guide members are disposed within the first battery compartment and configured to align and support the first battery within the first battery compartment,
second guide members are disposed within the second battery compartment and configured to align and support the second battery within the second battery compartment,
third guide members are disposed within the third battery compartment and configured to align and support the first battery within the third battery compartment, and
fourth guide members are disposed within the fourth battery compartment and configured to align and support the second battery within the fourth battery compartment.
